(19) United States
(12) Patent Application Publication
(10) Pub. No.: US 2005/0214086 A1
(43) Pub. Date: Sep. 29, 2005

(54) Hole cutter for wooden structures

(76) Inventor: James Nicholas, Union Beach, NJ (US)

Correspondence Address: Edward M. Fink, Esq., 51 Jamaica Street, Edison, NJ, 08820, US

(21) Appl. No.: 10/811,702

(22) Filed: Mar. 29, 2004

(51) Int. Cl. B23B 41/02

(52) U.S. Cl. 408/204

(57) ABSTRACT

A hole saw for cutting holes in wooden doors is described. The device includes a spring loaded base member which when actuated expels the unwanted waste material from the saw.

### FIELD OF THE INVENTION

This invention relates to a novel device for cutting holes in wooden structures. More specifically, the present invention relates to a power driven hole saw which is capable of cutting circular holes in wooden structures and mechanically expelling unwanted wood from the saw.

### BACKGROUND OF THE INVENTION

In the construction industry, a common step in the fabrication of structures involves the installation of wooden doors which are widely marketed and constitute a multi million dollar industry. In the fabrication of such doors, various sizes are generated to meet the needs of the builders. However, the doors as delivered require the installation of hinges and locking mechanisms. In order to install a locking mechanism it is common to employ a hole saw to accommodate such mechanism. Heretofore this end has involved the use of power driven saws which cut through the wooden doors and remove a circular section thereof. The portion removed typically requires removal from the circular saw by means of a pick or similar device which digs out the unwanted material in a non-uniform matter. As a result, this manual effort is time consuming and limits the rate at which multiple assignments can be completed. Accordingly, workers in the art have been seeking alternative means for effecting the noted end without the need for the time consuming step of removing waste material.

### SUMMARY OF THE INVENTION

In accordance with the present invention, the prior art limitations have been effectively obviated by means of a novel power driven hole saw. More specifically, the invention is directed to a power driven hole saw adapted with means for mechanically expelling unwanted material at the conclusion of the sawing process. In this manner, the artisan engaged in a multi-tasked function is capable of replicating the hole cutting process by an order of magnitude.

### BRIEF DESCRIPTION OF THE DRAWING

The invention will be more fully understood by reference to the following detailed description taken in conjunction with the accompanying drawing wherein:

FIG. 1 is a rear view of the hole saw of the invention in perspective;

FIG. 2 is a front view of the hole saw of the invention in perspective;

FIG. 3A is a front elevational view in cross-section of the device of the invention at full stroke of operation; and

FIG. 3b is a front elevational view in cross-section of the device of the invention in the full withdrawal state of operation.

### DETAILED DESCRIPTION OF THE INVENTION

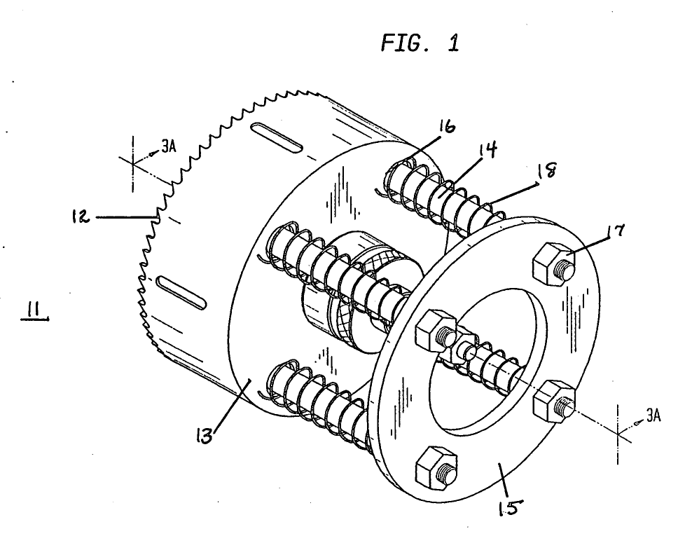

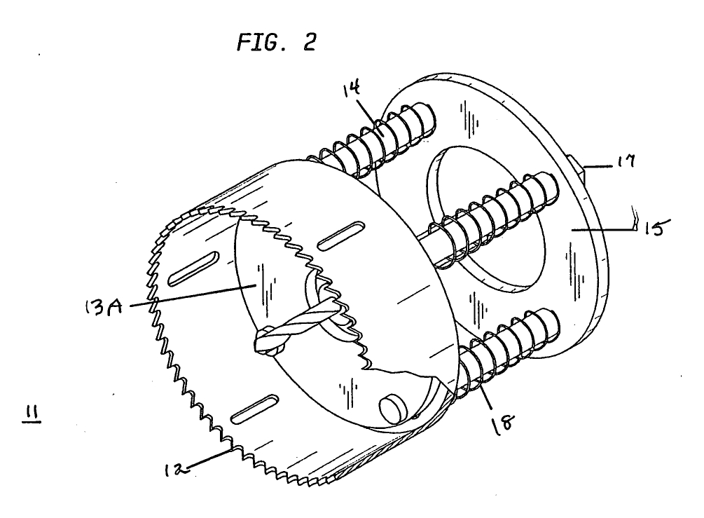

With reference now more particularly to FIG. 1, there is shown a rear view in perspective of the hole saw structure 11 of the invention. Shown in the Figure is hole saw blade 12 having a base member 13 adapted with a plurality of apertures suitable for accommodating bolts 14, a washer type structure 13A (shown in FIG. 2) which is disposed upon base 13 including apertures which conform to the apertures in base 13. and similarly accommodate bolts 14. Washer 13A has a centrally disposed aperture which coincides with a centrally located aperture in base 13 which is suitable for accommodating the bit of a power drill. Structure 11 is also adapted with a circular washer type structure 15 having a plurality of apertures 16 therein through which bolts 14 are inserted and connected to base 13 of blade 12. Plate 15 is held in place by providing nuts 17 which hold bolts 14 in place. The device is spring loaded by providing spring members 18 which encircle each of the bolts 14 of the device.

FIG. 2 is a front view of the structure of FIG. 1 showing the bit of the power drill 18 jutting through the central aperture of the device.

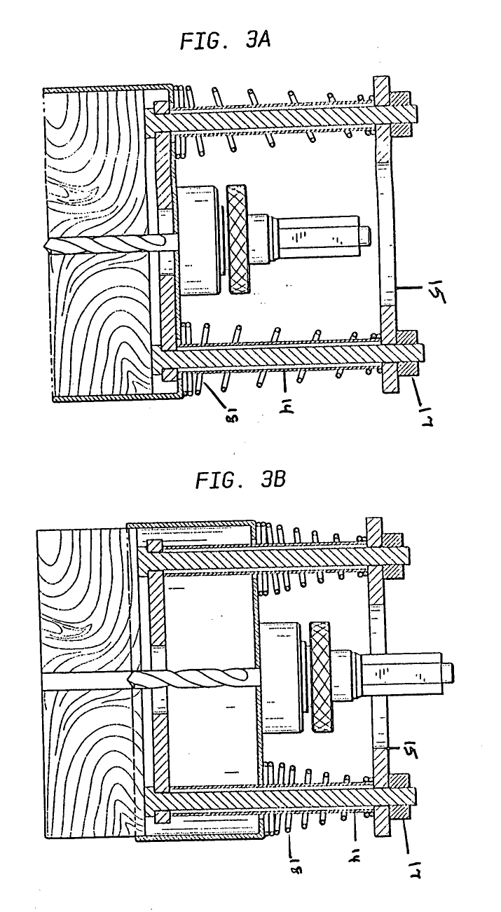

FIG. 3 is a front elevational view in cross section of the device shown in FIGS. 1 and 2 at full stroke. In other words, the figure shows the device when the circular saw has effected the cutting of the wooden structure. FIG. 4 is again a front elevational view in cross-section of the device of FIG. 1 but at the full withdrawal state at which point the sawing has been effected and the device is withdrawn.

### DETAILED DESCRIPTION OF THE INVENTION

In the operation of the device depicted in the drawing, the artisan begins the cutting operation by first determining the location of the door knob mechanism to be affixed to the structure of interest. Following, the power is actuated and the cutting of the wooden surface of interest is begun as blade 12 starts the cutting operation. At full stroke, as shown in FIG. 3A, blade 12 has completed its function and the desired hole in the structure of interest has been created. Then, the artisan withdraws the device from the completed structure and by applying pressure to base plate 15 the springs 18 are actuated and the unwanted wood contained in structure 11 is expelled from the device in its entirety. At that juncture, the artisan may move on to the next assignment without the need for a time consuming step of manually digging out the unwanted cut material from structure 11.

While the invention has been described in detail in the foregoing description, it will be understood by those skilled in the art that variations may be made without departing from the spirit and scope of the invention. Thus, for example, washer structures 13A and 15 may be made of a suitable metal or of wood. Similarly, the diameter of the hole saw may vary dependent upon the structure to be treated.

1. Hole saw structure including a circular blade including a base member having disposed thereon a first washer member, said base and first washer member having a plurality of apertures therein which coincide with each other and a central aperture for accommodating a power drill a plurality of spring loaded bolts which are connected to a second washer member and affixed thereto by nuts.

2. Structure in accordance with claim 1 wherein the washer members are constructed of wood.

3. Structure ion accordance with claim 1 wherein the washer members are constructed of metal.
